(19) United States
(12) Patent Application Publication
(10) Pub. No.: US 2024/0193794 A1
(43) Pub. Date: Jun. 13, 2024

(54) Method and Apparatus for Tracking Motion of Objects in Three-Dimensional Space

(71) Applicant: Queen's University at Kingston, Kingston (CA)

(72) Inventors: David Rival, Ottawa (CA); Frieder Kaiser, Ottawa (CA)

(21) Appl. No.: 18/279,416

(22) PCT Filed: Mar. 1, 2022
(86) PCT No.: PCT/CA2022/050287

§ 371 Date: Aug. 30, 2023

Related U.S. Application Data
(60) Provisional application No. 63/154,843, filed on Mar. 1, 2021.

(51) Int. Cl. G06T 7/246; G01P 5/00; G06T 7/60

(52) U.S. Cl. CPC G06T 7/248; G01P 5/001; G06T 7/60; G06T 2207/10048; G06T 2207/10088; G06T 2207/10116; G06T 2207/10132; G06T 2207/30108; G06T 2207/30241

(57) ABSTRACT

A method and apparatus for tracking movement of an object in three-dimensional (3D) space uses a using a single sensor to capture images of the object moving through the 3D space. A change in change in position of the object in the 3D space is determined based on a change in size of the object in the images. The change in position is used to construct a trajectory of the object and the trajectory represents the movement of the object through the 3D space. Trajectories of a plurality of objects may be determined. The objects may be naturally occurring, or they may be manufactured and introduced into the 3D space. The determined trajectories may be used to characterize a flow field in the 3D space and produce an output comprising a 3D representation of the flow field.

### RELATED APPLICATION

This application claims the benefit of the filing date of Application No. 63/154,843, filed on Mar. 1, 2021, the contents of which are incorporated herein by reference in their entirety.

### FIELD

The invention relates to methods and apparatus for tracking motion of objects in three-dimensional space. The methods and apparatus may be used to characterize three-dimensional flow fields by tracking movement of objects in the flow fields.

### BACKGROUND

Three-dimensional (3D) flow fields can be captured through a variety of multi-camera techniques including: 3D particle tracking velocimetry (3D-PTV) (Nishino et al. 1989; Maas et al. 1993), tomographic particle image velocimetry (tomo-PIV) (Elsinga et al. 2006), and most recently Shake-The-Box (Schanz et al. 2016). While such approaches have been optimized significantly in terms of accuracy and computational cost since their introduction (see for instance Scarano 2012), such techniques traditionally suffer from two major drawbacks that limit their transfer to industrial applications. First, particularly in air, the low scattering efficiency of the traditional tracers (diameter D=O (1 μm)) and the limited pulse energy of the light source limit the measurement volume of typical studies to V<100 cm³ (Scarano et al. 2015). The limited size of the measurement volume is often accounted for by using scaled models of the geometry under consideration, which, in air, results in lower Reynolds numbers (Re). When large-volume measurements are attempted they are either realized by stitching multiple small measurement volumes together (see e.g. Sellappan et al. 2018) or by repeating stereo PIV measurements on many planes (see e.g. Suryadi et al. 2010). Michaux et al. (2018) automatized the process of capturing multiple stereo-PIV planes using three robotic arms to adjust the laser and the two cameras. To perform volumetric measurements at higher Re, measurements can be conducted in water (see e.g. Rosi and Rival 2018). However, due to the presence of the water-air interface, the camera calibration poses a significant challenge. Furthermore, experiments in water often come at high costs in terms of both the facility and the model.

The second major issue preventing a broader application of 3D measurements, particularly at large scales, is its complexity. Expensive multi-camera systems and challenging calibration are required. Such complex set-ups are rarely possible in non-laboratory conditions, and are often too expensive and time-consuming for the result-oriented applications in industry. For instance in industrial applications as well as in large-scale wind tunnel testing, integral as well as point-measurement techniques remain the predominant tool for flow characterization. While well-established methods such as balances, pressure probes (single and multi-hole), and hot-wires provide a robust and affordable way to measure the aerodynamic loads or the local flow, these methods do not capture the coherent structures in the flow, which often are key to developing cause-effect relationships for such problems.

In air, the problem of limited light scattering for conventional objects (D=O (1 μm), Raffel et al. 2018) was tackled by testing larger tracer objects such as fog-filled soap bubbles (D=O (10 mm), Rosi et al. 2014), snowfall (D=O (1 mm), Toloui et al. 2014) and helium-filled soap bubbles (HFSB) (D=O (100 μm), Scarano et al. 2015). Larger tracer particles (D>100 m) allow for measurement domains at the scale of cubic meters (see e.g. HFSB in 0.6 m³ measurement volume, Huhn et al. 2017; HFSB in about 1.0 m³ measurement volume Bosbach et al. 2019). In addition, the enhanced light-scattering behaviour allows the use of less hazardous illumination sources such as searchlights (Toloui et al. 2014), LEDs (Buchmann et al. 2012; Huhn et al. 2017; Bosbach et al. 2019), and even natural light (Rosi et al. 2014). However, while large tracer particles enable the study of large-scale flows, for example, the atmospheric surface layer, the growing tracer size introduces new challenges with regards to flow-tracking fidelity (Scarano et al. 2015; Raffel et al. 2018) and thus limitations on the system resolution.

To reduce the system complexity for 3D measurements, single-camera approaches, as well as a compact multi-camera system, have been explored. Single-camera approaches based on defocusing were first suggested by Willert and Gharib (1992), who used three holes in the aperture to produce multiple images of the same particles on the camera sensor. Kao and Verkman (1994) introduced astigmatism to the optics of a microscope by a cylindrical lens to track the 3D motion of a single particle. Cierpka and Kähler (2012) adapted both principles (defocusing and astigmatism) successfully to enable 3D measurements in micro-PTV applications. Another promising single-camera approach demonstrated by Fahringer et al (2015) and Zhao et al. (2019) is light-field PIV (LF-PIV), where the third dimension is reconstructed using the information gathered from a single plenoptic camera. However, the method is limited by depth resolution and elongation effects of the reconstructed particles. Moreover, Kurada et al (1995) proposed a prism that enabled recording of three perspectives with a single camera chip. The prism was utilized by Gao et al (2012) to perform volumetric measurements. As the former methods decrease the resolution of each view, Schneiders et al. (2018) introduced a coaxial volumetric velocimeter (CVV). The CVV integrates four cameras and the laser light illumination into a single module. Jux et al. (2018) combined the CVV with a robotic arm to automatically measure multiple subsets of a large measurement volume, providing time-averaged data in large volumes around complex geometries.

### SUMMARY

One aspect of the invention relates to a method for tracking movement of an object in three-dimensional (3D) space, comprising; using a single sensor to obtain images of the object moving through the 3D space; using a processor to determine a change in position of the object in the 3D space based on a change in size of the object in the images; and use the change in position to construct a trajectory of the object; wherein the trajectory represents movement of the object through the 3D space.

In one embodiment, determining a change in size of the object in the images comprises determining a first size of the object in a first image at a first instance in time; determining a second size of the object in a second image at a second instance in time; using a difference in the first and second sizes of the object as the change in size of the object.

In one embodiment, determining a change in size of the object in the images comprises using an object detection algorithm.

In one embodiment, determining a change in size of the object in the images comprises detecting features in a first image of the object at a first instance in time; detecting the features in a second image of the object at a second instance in time; using the features in the first and second images to determine the change in size of the object.

In one embodiment, the features are glare points and the change in size of the object is determined by extracting temporal evolution of spacing of the glare points.

In one embodiment, the change in position of the object is determined two or more times.

In various embodiments, changes in positions of two or more objects in the images may be determined. The objects may be of substantially uniform size and shape.

In various embodiments, the single sensor may be adapted to capture images based on a modality selected from light (visible, infra-red (IR)), ultrasound (US), X-ray, radio frequency (RF), and magnetic resonance (MR).

In one embodiment, the single sensor comprises a camera.

In one embodiment, the object is naturally-occurring in the 3D space.

In one embodiment, the object is manufactured.

In one embodiment, the object is released into the 3D space.

In one embodiment, the trajectory may be used to characterize a flow field in the 3D space, and the method may include outputting a 3D representation of the flow field.

Another aspect of the invention relates to apparatus for tracking movement of an object in three-dimensional (3D) space, comprising; a single sensor that captures images of the object moving through the 3D space; a processor that determines a change in position of the object in the 3D space based on a change in size of the object in the images; and uses the change in position to construct and output a trajectory of the object; wherein the trajectory represents movement of the object through the 3D space.

In one embodiment, the processor determines the change in size of the object in the images by: determining a first size of the object in a first image at a first instance in time; determining a second size of the object in a second image at a second instance in time; using a difference in the first and second sizes of the object as the change in size of the object.

In one embodiment, the processor determines the change in size of the object in the images comprises using an object detection algorithm.

In one embodiment, the processor determines the change in size of the object in the images by detecting features in a first image of the object at a first instance in time; detecting the features in a second image of the object at a second instance in time; using the features in the first and second images to determine the change in size of the object.

In one embodiment, the features are glare points and the change in size of the object is determined by extracting temporal evolution of spacing of the glare points.

In one embodiment, the processor determines the change in position of the object two or more times.

In one embodiment, the processor determines changes in positions of two or more objects in the images. The objects may be of substantially uniform size and shape.

In various embodiment, the single sensor is adapted to capture images based on a modality selected from light (visible, infra-red (IR)), ultrasound (US), X-ray, radio frequency (RF), and magnetic resonance (MR).

In one embodiment, the single sensor comprises a camera.

In one embodiment, the object is naturally-occurring in the 3D space.

In one embodiment, the object is manufactured.

In one embodiment, the object is released into the 3D space.

In one embodiment, the processor uses the trajectory to characterize a flow field in the 3D space and outputs a 3D representation of the flow field.

Another aspect of the invention relates to an apparatus and associated methods for characterizing a flow field of a 3D space, comprising a single sensor that captures images of one or more object moving through the 3D space; a processor that processes the images to determine a change in position of the one or more object in the 3D space based on a change in size of the one or more object in the images; and use the change in position to construct a trajectory of the one or more object through the 3D space; and output the trajectory of the one or more object in the 3D space and/or a 3D representation of the flow field of the 3D space.

Another aspect of the invention relates to non-transitory computer-readable storage media containing stored instructions executable by a processor, wherein the stored instructions direct the processor to execute processing steps on image data of one or more object moving through 3D space, including determining position and trajectory of the one or more object in the 3D space, using the position and trajectory of the one or more object to characterize a flow field of the 3D space, and optionally outputting a 3D representation of a flow field of the 3D space, as described herein.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a flow diagram showing processing steps, at least some of which may be executed by a processor, for computing 3D tracks from 2D object images, according to one embodiment.

FIG. 2A is a diagram of an experimental set-up for an embodiment based on object tracking using bubble size.

FIG. 2B (upper panel) is a diagram representing bubble images recorded at instances t₁ and t₄ with varying bubble image size (d_{b}); and (lower panel) a diagram representing linear optics producing the bubble images of size d_{B} dependent on bubble size (D_{B}) and position (o).

FIGS. 2C and 2D show raw images of bubbles illuminated by an LED array or only peripheral light, respectively, wherein the rectangles in FIG. 2D indicate bubbles identified using an object detection algorithm.

FIG. 3A is a diagram showing imaging of bubble glare points (dots separated by D_{B}) and the dependence of glare-point spacing D_{G} on the light source angle θ, according to one embodiment.

FIG. 3B is a diagram showing that as a bubble moves towards the camera (lens), the depth (object distance o) changes and leads to a change in the glare-point spacing d_{G} on the image plane.

FIG. 4A is a plot of depth of field limited by oₘᵢₙ and oₘₐₓ for varying f-numbers ( [symbol] ) for a constant focus distance o_{f}=5 m.

FIG. 4B is a plot of image glare-point spacing d_{G} for bubbles of diameter D_{B}∈{10 mm, 25 mm} for different object distances (o) for a set-up with f=60 mm, [symbol] =11, and of =5 m for a camera with 10 m pixel size.

FIG. 5 is a diagram of an experimental set-up (not to scale) in a wind tunnel including position of the bubble generators in the settling chamber, and shows a close-up view of the test section with a measurement volume, light source, and the cameras.

FIG. 6 is a flow diagram showing main processing steps, at least some of which may be executed by a processor, for computing 3D tracks from 2D bubble images, according to one embodiment.

FIGS. 7A and 7B are diagrams showing two views of a total of 2774 reconstructed bubble tracks at U_{∞}=30 m/s using the set-up of FIG. 5.

FIG. 8 is a 3D plot of averaged velocity data at U_{∞}=30 m/s, showing in-plane velocity visualized by direction (vectors) and magnitude (contour plot) in four planes at different locations behind the model truck (shaded rectangle) of the set-up of FIG. 5.

FIG. 9 is a plot of streamlines from the perspective of camera A in the set-up of FIG. 5, for U_{∞}=30 m/s, according to streamwise vorticity.

### DETAILED DESCRIPTION OF EMBODIMENTS

Embodiments described herein provide methods and apparatus for tracking motion of one or more objects over a small or large volume (i.e., a 3D space) that enable affordable and efficient measurements using a single sensor. Compared to prior methods, embodiments significantly reduce experimental effort. Tracking motion of objects as described herein provides time-resolved measurements that enable characterization of flow fields in very large volumes, e.g., full-scale measurements in the atmospheric boundary layer, as well as in confined spaces, such as airflow in indoor spaces (e.g., offices, classrooms, laboratories, homes, etc.). Embodiments provide methods and apparatus for tracking motion of objects in 3D spaces and characterizing flow fields in real time. In the context of the recent pandemic, such indoor applications could help to reduce infection risk by designing appropriate air circulation, ensuring frequent air exchange, and avoiding direct airflow from individual to individual. In addition, embodiments may be adapted to track the motion of objects in volumes comprising various fluids (i.e., liquids, gases), or volumes in a vacuum (e.g., in outer space).

Embodiments use a single sensor 3D measurement approach to track one or more objects in a 3D space. The sensor captures images of one or more objects moving through the 3D space. The size of an object in an image captured by the sensor depends on its distance from the sensor as it travels through the 3D space. When the size of an object is known (i.e., the actual size, or the size with respect to a reference point), then by determining the change in size of the object in images captured at different times, the trajectory of the object may be constructed. As described herein, various techniques may be used to determine the size of an object in images captured by the sensor. For example, embodiments may be based on detecting glare points on objects in the images, while other embodiments may use object detection algorithms.

Embodiments may be implemented using a sensor technology that can capture images of an object moving in a 3D space, from which information (i.e., one or more features of the object) can be extracted to determine size of the object. Examples of such technology include, but are not limited to, those based on a modality selected from light (visible, infra-red (IR)), ultrasound (US), X-ray, radio frequency (RF), and magnetic resonance (MR).

Some embodiments may use objects of known size. For example, in some applications such as controlled experiments, studies in confined or enclosed 3D spaces, etc., in which objects are released into a 3D space, the objects are of known size. Also, the objects may be of substantially uniform shape. Examples of such objects include, but are not limited to, bubbles, balloons, particles prepared from selected materials, etc.

In other embodiments, the objects may not be of known or uniform size. For example, in some applications such as large enclosed spaces and outdoors, naturally occurring objects, such as snowflakes, ashes, or other particulate matter (e.g., resulting from natural events), seeds, animals such as birds or insects, etc., may be tracked. Alternatively, the object(s) may be manufactured (i.e., “man-made”), e.g., drones, aircraft, bubbles, balloons, particles prepared from selected materials, etc., and released into the space, or the objects may be debris or particulate matter (e.g., resulting from catastrophic events), etc. The size of such objects may be estimated based on experience or known parameters (e.g., size of a known species of bird or insect, or type of drone or aircraft). In the absence of known parameters various techniques may be employed to estimate size of objects, for example, a second sensor may be used, or the object size may be estimated when the object is at a known position, or suitable illumination can provide an object size estimate, etc. An embodiment for object tracking based on estimating size of objects is described in detail in Example 1.

Embodiments suitable for in very large measurement volumes (e.g., large enclosed spaces, outdoors) may include mobile apparatus for releasing objects of known size and of substantially uniform shape and tracking their movements. For example, in one embodiment a drone is equipped with a bubble generator, a sensor (e.g., camera), a global positioning system (GPS) sensor, and acceleration sensors or an inertial measurement unit (IMU). The bubble generator releases bubbles and position and velocity of the drone/sensor and bubbles are tracked over time as the bubbles move away from the drone. Images of the bubbles acquired by the camera are processed according to methods described herein to characterize the flow field in real-time in a very large measurement volume. Such an embodiment may be deployed in a wide variety of applications to measure the flow field in its vicinity, wherein quantities such as mean flow velocity and turbulence ratio may be derived and evaluated in real-time. Applications include, for example, evaluation of sites for wind turbine installations and optimization of wind turbine placement, where local weather conditions, complex terrain, etc., render studies based on weather models, historic weather data, and conventional flow measurement techniques to be of limited value. In contrast, a mobile embodiment as described herein allows the identification of suitable locations for wind turbine plants and placement of wind turbines, where a significant performance increase may be expected. Other applications may include measurements in research and development (e.g., design and optimization of industrial wind tunnels), on-road measurements for aerodynamic vehicle optimization, efficient disaster response when airborne contaminants are involved, and flow assessment in urban areas to predict aerodynamic and snow loads for planned buildings.

Embodiments may be based on tracking objects by tracking identifiable features in the images of the objects captured by the sensor. An object may have a characteristic related to surface properties, material properties, etc. that results in one or more identifiable features in the images. In some embodiments, an identifiable feature may be present in the images even if the object itself is not rendered in the images. An example of such a feature is glare points (or glints) produced by incident light on a reflective surface of the object. For example, when light is directed to a substantially spherical object with a reflective surface, a sensor such as a camera will capture resulting glare points on the reflective surface. The glare points in an image of the object may be used to determine the size of the object, and a temporal sequence of images may be used to determine a change in size of the object in the images relative to the sensor, and hence to construct the trajectory of the object.

A non-limiting example of a reflective object that may be tracked is a bubble. Bubbles, such as those produced from soap, are good candidates for use in embodiments because they are inexpensive and can easily be produced and dispersed in large quantities, they are very light and thus able to follow flow (e.g., of air) closely, and they can be relatively environmentally-friendly. Bubbles may be, e.g., centimeter-sized, which is a good compromise between the ability to detect glare points, strength/longevity of the bubbles, and their ability to follow fluid (e.g., air) flow, although other sizes may be used. However, as bubbles become larger they have more inertia which reduces their ability to follow air flow. Furthermore, larger bubbles deform more easily, rendering a glare point approach as described herein less accurate. A camera may be used as a sensor to capture images of bubbles, which may be illuminated (e.g., using white light) to create glare points on the bubbles. Depth (i.e., size) of the soap bubbles may be determined from the glare-point spacing in the images.

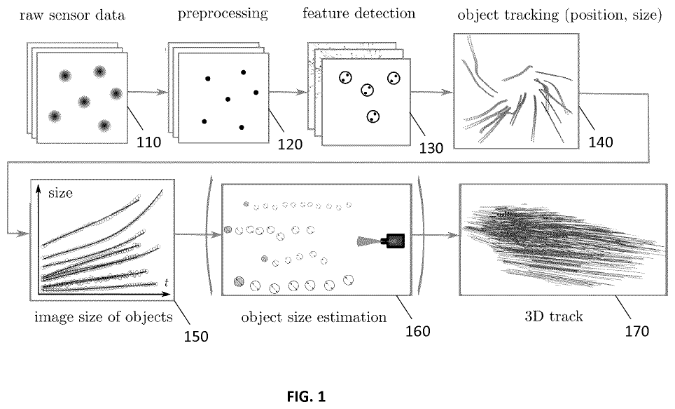

Embodiments may include one or more processor, e.g., a computer, having non-transitory computer-readable storage media containing stored instructions executable by the one or more processor, wherein the stored instructions direct the processor to carry out processing steps on image data of one or more object moving through 3D space, including determining position and trajectory of one or more object in 3D space, using the position and trajectory of the one or more object to characterize a flow field of the 3D space, and optionally outputting a 3D representation of a flow field of the 3D space, as described herein. For example, one or more processing steps such as those shown in the embodiment of FIG. 1 may be executed by the one or more processor.

FIG. 1 is a flow chart showing processing steps according to one embodiment. At 110 raw sensor data (i.e., images of one or more objects captured by a single sensor over a period of time) are received by the processor. The images may be subjected to preprocessing 120, where embodiments might include subtraction of background data (e.g., a background image), contrast enhancement, noise reduction, and/or image stabilization. In the next step 130, characteristic features of the observed object(s) are detected in the images, in particular the size of object(s), and/or relative distance of different features of object images may be extracted to obtain an estimate of the object size in the images. In some embodiments, feature detection may be at least partially implemented using an object detection algorithm. Such an algorithm may be based on a technique such as machine learning using training data obtained for similar objects. In other embodiments, feature detection may be threshold-based (e.g., a threshold corresponding to image brightness) and connect features (e.g., glare points on objects) based on their relative orientation. Feature detection is repeated for a plurality of time instances and the movement and size change of the object is obtained by connecting the detected objects or features from subsequent time instances to a two-dimensional track 140. When an object (of substantially constant physical size) moves relative to the sensor not only the position of the object on the images changes, as determined at 140, but also its size changes in time as determined at 150. Step 160 is optional and is where the object size is estimated from the data. However, in embodiments in which the physical size of the object(s) is known, step 160 is not implemented. Otherwise, if the physical size of one or multiple objects is not known the additional processing at 160 is used to estimate the physical object size. Finally, the information extracted in steps 130, 140, and 150, and optionally 160, are used to determine the position and hence trajectory of the object(s) in three-dimensional space and time at 170, using, e.g., Equation (4).

Embodiments based on use of bubbles as tracked objects are described in detail in Examples 1, 2, and 3. The Examples are included to show how embodiments of the invention may be implemented, and are not intended to limit the scope of the invention in any way.

### Example 1

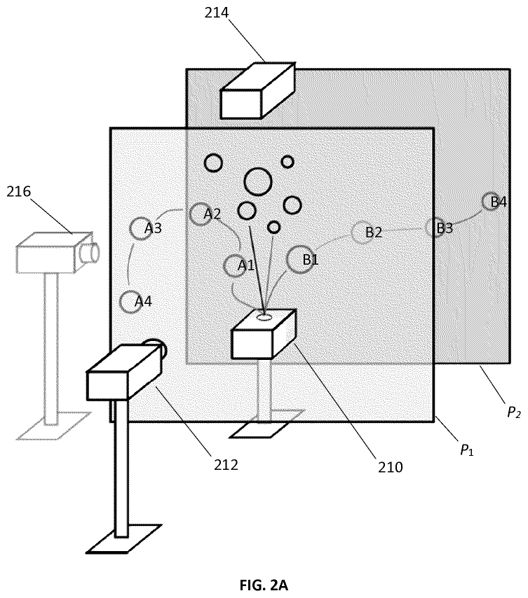

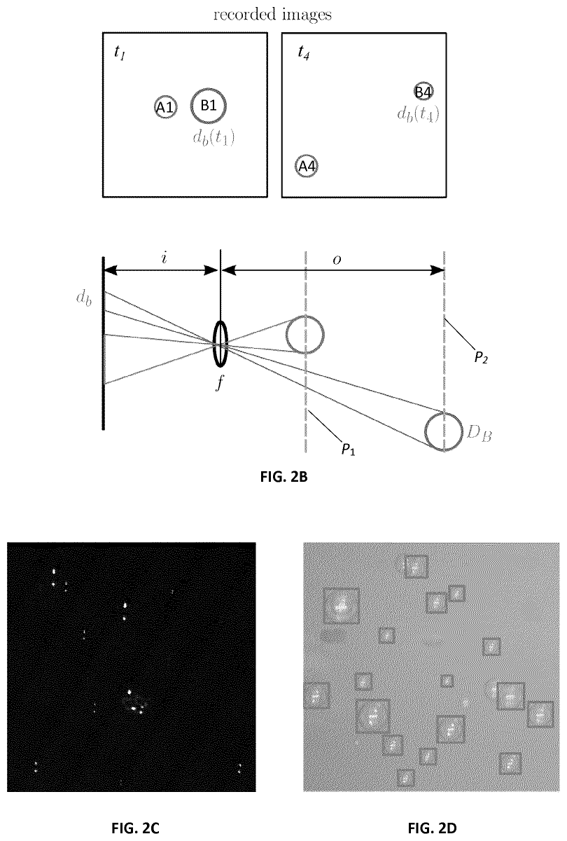

An embodiment was implemented to demonstrate 3D object tracking based on object size estimation. The implementation is shown diagrammatically in FIG. 2A.

A test flow was examined in a 3m×4m×3m room equipped with two portable fans to generate a low-speed air circulation. As shown in FIG. 2A, a commercial bubble generator 210 was set up in the middle of the room, providing large soap bubbles (10 mm≤D_{B}≤25 mm) as objects. A single camera 212 with a small focal length was used to capture the object tracks. The planes P₁ and P₂ represent two planes at a different distance from the camera in which bubble images may be captured. An LED light source 214 was used to illuminate the bubbles. As noted above, dependent on the distance of the bubble to the camera o(t) the bubble image size d_{B}(t) varies in time. For example, in FIG. 2A bubble A remains at the same distance from the camera 212 as it moves through the 3D space while staying in plane P₁, shown at four instances in the temporal sequence t₁-t₄ (A1-A4) in which it is the same size (as viewed by the camera). In contrast, bubble B moves away from the camera 212 and accordingly it appears smaller in the temporal sequence t₁-t₄ (B1-B4) as the bubble moves from plane P₁ to P₂. FIG. 2B, upper panel, shows the bubble sizes captured at instances t₁ and t₄ (i.e., the images of A1 and B1 and the images of A4 and B4, respectively). Assuming o>>i (image distance i from camera chip to lens f, see FIG. 1B, lower panel where the dashed lines represent two image planes P₁ and P₂, leads to i≈f, from which a simplified magnification equation (e.g., Equation (4)) may be derived as discussed in detail in Example 2, below.

Once a bubble is generated, the bubble size (D_{B}) can be determined by Equation (4) as the distance between the camera and the bubble generator o(t=t₀) is known. Knowing D_{B}, Equation (4) allows reconstruction of the bubble position in three dimensions for all time instances until the bubble leaves the field of view or bursts. While low object densities are required to avoid ambiguity in the reconstruction, very long tracks were extracted (˜80 time instances). The long tracks allow analysis of the material transport in the room, both instantaneously and statistically.

In this example, accuracy of the method was evaluated by recording the same bubble from two different perspectives (i.e., by using an additional camera 216, see FIG. 2A) and comparing the resulting trajectories from the two cameras. (The additional camera was not used as part of the object tracking method.) Thereafter, different approaches to optimize the experimental set-up were investigated. The slow flow velocities used allow using low-cost camera modules at low speeds. The flow was recorded with a PCO edge 5.5 (60 Hz, 2560×2160 px², f=35 mm) and a smartphone camera (60 Hz, 1920×1080 px², f=14 mm, equivalent focal length f_{eq}=35 mm), simultaneously. Furthermore, two different illumination approaches were compared. First, an LED array was placed perpendicular to the camera view, leading to two distinct glare points for each bubble, as shown in FIG. 2C. Glare-point spacing can then be used to estimate the size of the bubble image (e.g., using Equation (1), see Example 2, below). In an alternative approach, no dedicated light source was used. FIG. 2D shows the results of an object detection algorithm identifying the bubbles, their positions, and image sizes (Abadi et al., 2015). While not all bubbles were detected at all times, with sufficient peripheral light and enough training data, object detection provides sufficient accuracy to reconstruct the three-dimensional bubble trajectories.

### Example 2

This example describes use of glare points of bubbles in 3D object tracking.

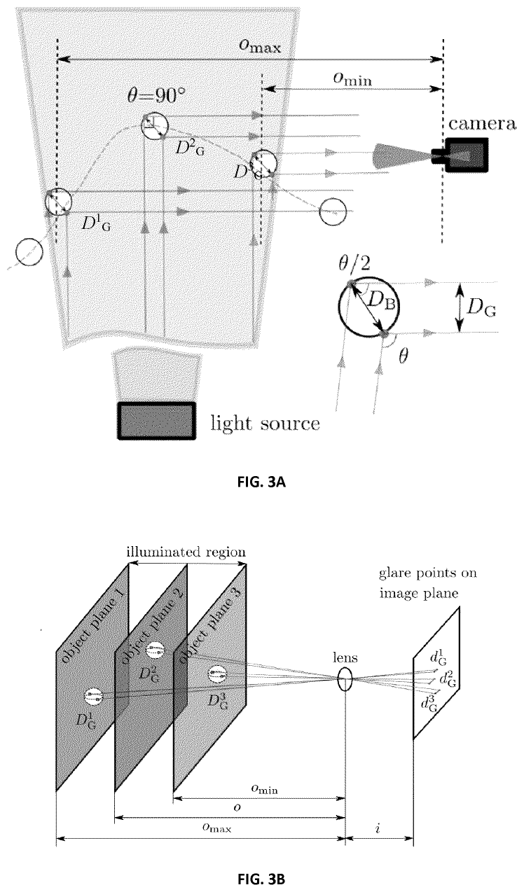

Consider a spherical air-filled soap bubble of diameter 10 mm<D_{B}<25 mm much larger than the soap film thickness h=0.3 μm<<D_{B}. When the bubble is illuminated by a parallel light beam, a camera at an observation angle θ with respect to the illumination direction captures several reflections (glare points) on the bubble surface. For θ≈90 the two glare points of highest intensity are a result of external and internal reflections, respectively (see FIG. 3A), whereas the remaining glare spots (typically at least one order of magnitude less intense) are ascribed to higher-order reflections. For a small soap film thickness, the relation for the glare-point spacing (D_{G}) between the two brightest glare points simplifies to

D_{G}=D_{B} sin(θ/2). (1)

Hence, the glare-point spacing is directly proportional to the bubble diameter. If the light source and the camera are far away from the measurement volume, a constant 6 can be assumed throughout the whole measurement volume. For θ=90 this leads to D_{G}=\sqrt{2}/2D_{B}, as shown in FIG. 3A. The ratio of bubble size to glare-point spacing also holds for the image of the bubble captured on a sensor such that d_{G}=\sqrt{2}/2d_{B}.

Assuming that the bubbles remain spherical with constant diameter D_{B}, and that the variation of θ is negligible along the bubble's path, the image glare-point spacing (d_{G}) is related to D_{B} by the optical magnification factor M, as shown in FIG. 3B:

$$M = \frac{\sqrt{2} {d}_{G}}{{D}_{B}} = \frac{{d}_{B}}{{D}_{B}} = i / o \qquad ( 2 )$$

where i is the image distance and o the object distance (Raffel et al. 2018). For o>>i the lens equation

f⁻¹=o⁻¹+i⁻¹ (3)

leads to f≈i, where f is the camera lens focal length. Equation (2) simplifies to

$$o = \frac{{D}_{B} f}{\sqrt{2} {d}_{G}} . \qquad ( 4 )$$

With Equation (4), and for known bubble diameters D_{B}, the motion of a bubble in 3D space can then be extracted by a single camera.

The extraction of the out-of-plane position for each bubble requires knowledge about the bubble size (D_{B}). The error estimate for D_{B} propagates linearly into the estimate of o (Equation (4)), and therefore also into derived quantities such as the velocity or the material acceleration. The optimal solution would be a bubble generator (currently in development) that produces equally-sized bubbles of known size. However, alternate approaches are possible. For instance, if the illuminated region and the flow direction are known, D_{B} can be estimated as soon as the bubble first appears in the image. Alternatively, D_{B} can be estimated by a secondary view through the principle of photogrammetry. These details are outlined below.

Embodiments may exhibit a limited resolution in the out-of-plane direction. In particular, the out-of-plane component is resolved by the difference between d_{G}(oₘᵢₙ) and d_{G}(oₘₐₓ), where oₘₐₓ is the maximum and oₘᵢₙ the minimum object distance, respectively. For a given measurement volume depth oₘₐₓ−oₘᵢₙ, the value of

$$Δ {d}_{G} = {d}_{G} ( {o}_{min} ) - {d}_{G} ( {o}_{max} ) = {fD}_{G} ( \frac{1}{{o}_{min}} - \frac{1}{{o}_{max}} ) = {fD}_{G} \frac{{o}_{max} - {o}_{min}}{{o}_{max} {o}_{min}} \qquad ( 5 )$$

has to be maximized. To allow for bright images, a small f-number ( [symbol] ) is preferred. As small [symbol] results in a limited depth-of-field (DOF), the limits of the measurement volume (oₘₐₓ and oₘᵢₙ) are set to the limits of acceptable image sharpness (Greenleaf 1950):

$${o}_{max} = \frac{{o}_{f} {f}^{2}}{ℱ c ( {f}^{2} / ( ℱ c ) - {o}_{f} )} \\ {o}_{min} = \frac{{o}_{f} {f}^{2}}{ℱ c ( {f}^{2} / ( ℱ c ) - f + {o}_{f} )} , \qquad ( 6 )$$

where o_{f} is the focus distance, and c is the circle of confusion that describes the acceptable blurriness of the image. The combination of Equations (5) and (6) leads to the simple expression

$$Δ {d}_{G} = \frac{{D}_{G} ℱ c}{{o}_{f} f} ( 2 {o}_{f} - f ) \approx \frac{2 {D}_{G} ℱ c}{f} , \qquad ( 7 )$$

where in the last step o_{f}>>f is assumed. Equation (7) implies that shorter focal lengths will allow for better depth resolution. However, small f results in wide opening angles and thereby leads to a measurement volume that is shaped more like a truncated pyramid than that of a cuboid. Furthermore, for small f the measurement volume is located close to the camera, in turn possibly modifying the flow. Therefore, f may be selected for a compromise between good out-of-plane resolution and sufficient distance between the camera and the measurement volume.

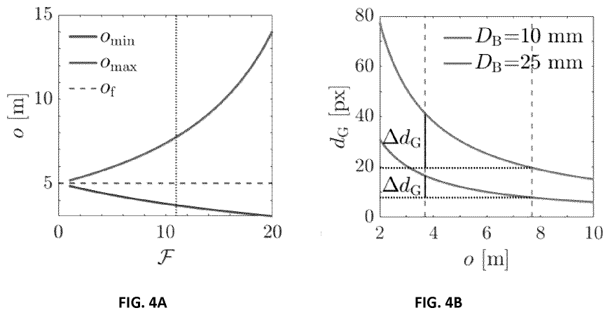

For example, in one embodiment f=60 mm (e.g., AF Micro-Nikkor 60 mm f/2.8D) may be selected as a compromise between good out-of-plane resolution and sufficient distance between the camera and the measurement volume oₘᵢₙ. FIG. 4A presents oₘₐₓ and oₘᵢₙ as a function of [symbol] for c=23 μm, which corresponds to 2.3 px for a camera used in Example 3 (below), a Photron™ mini-WX 100. An f-number of [symbol] =11 provides sufficiently bright images. For o_{f}=5 m a DOF of oₘₐₓ−oₘᵢₙ=L=4.0 m can be achieved. FIG. 4B exemplifies the interplay of D_{B}, o, and d_{G} for two different bubble sizes. As shown in FIG. 4B for this camera (Photron mini-WX 100, pixel size: 10 m) the aforementioned parameters lead to a range of 8 px<d_{G}<17 px (Δd_{G}=9 px) for a bubble of diameter D_{B}=10 mm and 20 px<d_{GB}<41 px (Δd_{G}=21 px) for a bubble of diameter D_{B}=25 mm in the measurement volume. Because Δd_{G} scales approximately linearly with D_{B} (and therefore D_{B}) as shown in Equation (7), a larger bubble will result in better out-of-plane resolution. Assuming a Gaussian peak fit would provide an approximate accuracy of 0.1 px for the position of the glare-point center in the image (Raffel et al. 2018), a larger d_{B} further decreases the uncertainty of the position and velocity reconstruction via Equation (4).

### Example 3

A 3D object tracking embodiment using soap bubbles as tracked objects was implemented using a 30% scale tractor-trailer model at a 9° yaw angle in a wind tunnel at the National Research Council (NRC) in Ottawa, Canada.

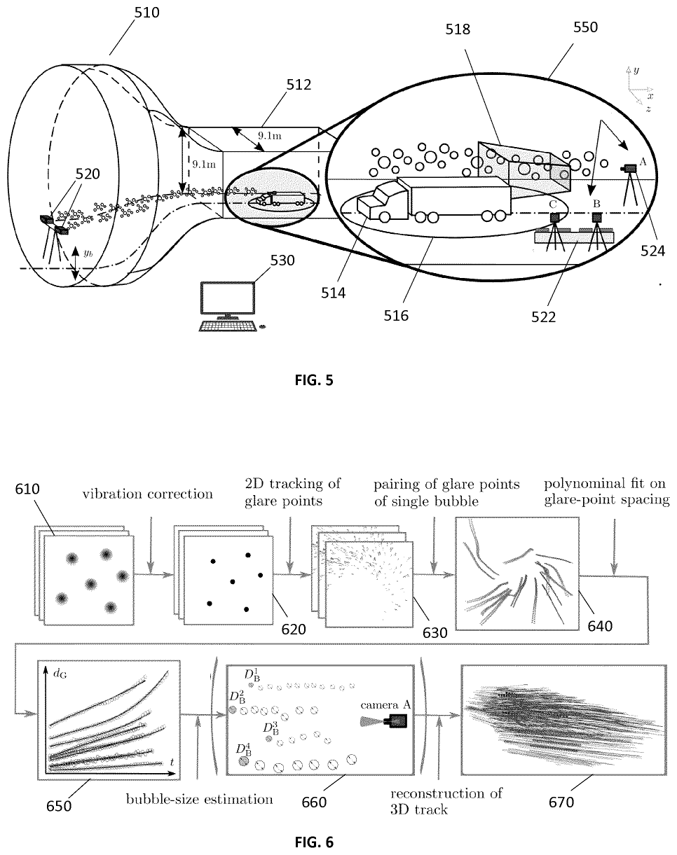

FIG. 5 is a diagram showing the experimental set-up. Measurements were conducted in the 24.0 m×9.1 m×9.1 m test section 512 of a large low-speed wind tunnel 510 at the NRC. A close-up of the set-up in the test section 512 is shown within the heavy line 550. The wake of a 30%-scale tractor-trailer model 514 based on a tractor (Kenworth T680 with 1.93 m sleeper) and a trailer (16.15 m dry-van with a height of 1.23 m) was studied. The tractor-trailer model 514 was placed on a 6.1 m-diameter turntable 316, which was rotated to produce a 9° yaw angle between flow and truck. A measurement volume 518 of approximately 4.0 m×1.5 m×1.5 m (V=O (10 m³)) was captured with a high-resolution camera (A) 524 (Photron mini-WX 100, AF Micro-Nikkor 60 mm f/2.8D, 2048px×2048px) with the aperture set to [symbol] =11. The measurement volume 518 started at the back of the trailer and extended ˜4 m in the x-direction (see FIG. 5). This placement of the measurement volume allows for the capture of the vortical wake evolving due to the yawed configuration of the trailer.

To generate tracked objects, two commercial bubble generators 520 (Antari B200) each with a production rate of ˜40 bubble/s were used. The diameters of the air-filled soap bubbles varied in the range 10 mm<D_{B}<25 mm.

Both bubble generators were placed ˜20 m upstream of the measurement volume in the settling chamber of the wind tunnel at a height y_{b}=4 m; see FIG. 5. Two considerations influenced the positioning of the bubble generators in the settling chamber. First, the position upwind of the contraction (contraction ratio C=A_{S}/Aₜ=6:1 between the cross section of the settling chamber A_{S} and the test section Aₜ) allowed for sufficiently slow wind speeds for the bubble generators to operate within their specifications. Second, the disturbances of the flow introduced by the generator bodies were significantly damped by the time the bubbles travelled to the measurement volume. The commercial bubble generators used were not optimized with regard to aerodynamic shape and seeding output (bubbles per second). Therefore, flow statistics obtained might be biased (influence of the bubble generator wake) and low-seeding densities lead to long measurement times for converged statistics and sparse instantaneous measurements.

Once the soap bubbles entered the measurement volume 518, they were illuminated by an array of four pulsed high-power LEDs 522 (LED-Flashlight 300, LaVision GmbH) placed in a series configuration, as shown in FIG. 5. The bubble glare points were captured by the camera (A) 524 and image data were stored on a computer 530 for processing.

To estimate the size of each bubble, two cameras (B and C) (Photron SA4, AF Nikkor 50 mm f/1.4D, [symbol] =11, FIG. 5) were used to capture a secondary view to determine the bubble sizes via photogrammetry, and the captured image data were stored on the computer 530 for processing. It is noted that this step is not needed if the bubbles are of known and uniform size, and was only used here to confirm the bubble size estimate. All steps of the 3D trajectory reconstruction were performed only with the data of camera (A) 524.

A total of 19 runs (5400 images) were collected to assess the wake-flow characteristics at free-stream velocities of U_{∞}=8 m/s (3 runs) and U_{∞}=30 m/s (16 runs), respectively. Images were recorded at frequencies of F_{cam}=150 Hz (U_{∞}=8 m/s) and F_{cam}=500 Hz (U_{∞}=30 m/s). The cameras were mounted onto the wind-tunnel floor with tripods and vibration-damping camera mounts, and the tripods were then fixed with multiple lashing straps.

FIG. 6 is a flow diagram showing processing steps used in this example, which were executed by the processor of the computer 530. It will be appreciated that in other embodiments and implementations, processing may omit steps, such as vibration correction and/or bubble size estimation, and/or add other steps.

At high wind speeds, the shell of the wind tunnel vibrates at frequencies within the range of 9-40 Hz. While the tractor-trailer model 514 was mounted on the non-vibrating turntable 516, the cameras experienced significant vibrations. To correct for the vibrations during image processing, non-vibrating reference points were placed in the measurement volume. For camera (A) 524, two yellow stickers were attached to the left edge at the back of the trailer. For cameras B and C stickers were attached to the opposite wind tunnel walls. As the first step of processing 610, the raw images received by the processor were stabilized 620 (translation and rotation) through cross-correlation of the sticker positions throughout the time series. Thereafter, glare points were tracked 630 using standard two-dimensional PTV (DaVis 8.4.0, LaVision GmbH). A representation of a two-dimensional vector map is shown at 630.

Subsequently, at 640 individual glare point tracks were determined from temporal sequences of 2D images originating from individual bubbles, and then the 2D tracks of the same bubble were paired. The pairing was based on a series of conditions. First, the paired tracks have to be reasonably close and their velocities have to be similar. Second, the position of the light source determines the relative orientation of the individual glare points of the same bubble. After pairing, at 650 the temporal evolution of the glare-point spacing (d_{G}(t)) was extracted. To reduce measurement noise, d_{G}(t) was smoothed by applying a third-order polynomial fit.

Without optimal bubble generators that produce bubbles of uniform and known size, in this example, an additional processing step 660 was implemented to estimate size D_{B} for each bubble once it appeared in the FOV using cameras B and C. The flow was recorded from a second perspective and D_{B} was determined via photogrammetry. With known D_{B}, the 3D position of each bubble can be estimated at all times from a single perspective. In particular, bubble tracks of camera A were matched with the second perspective (cameras B and C) via triangulation. Once D_{B} was known the second perspective was disregarded and the complete 3D track was reconstructed from a single view. With an optimal bubble generator equally-sized bubbles can be generated, and the step 660 can be omitted. With known D_{B}, for camera A the object distance (o) of each bubble was estimated from the glare-point spacing (d_{G}) in Equation (2).

All cameras were calibrated by the method suggested by Zhang (2000), providing both the internal camera matrix I and the external matrix E=(R|T) consisting of the rotation matrix R and the translation vector T. The calibration maps the coordinates (x,y,z) from the real-world coordinate system to the frame of reference of the camera chip (X,Y)

$$[ \begin{matrix}X \\ Y \\ m \\ \end{matrix} ] = IE [ \begin{matrix}x \\ y \\ z \\ 1\end{matrix} ] = IR [ \begin{matrix}x \\ y \\ z\end{matrix} ] + T = I [ \begin{matrix}{x}_{c} \\ {y}_{c} \\ {z}_{c} = o\end{matrix} ] , \qquad ( 8 )$$

where m is initially unknown. For sake of clarity, a second real-world coordinate system was introduced with the coordinates (x_{c},y_{c},z_{c}) that shares the origin and orientation of the coordinate system of camera A. Since z_{c}=o is then known, Equation (8) provides (x_{c},y_{c},z_{c}), which by translation (T) and rotation (R) leads to (x,y,z), and thereby the three-dimensional tracks were determined at 670.

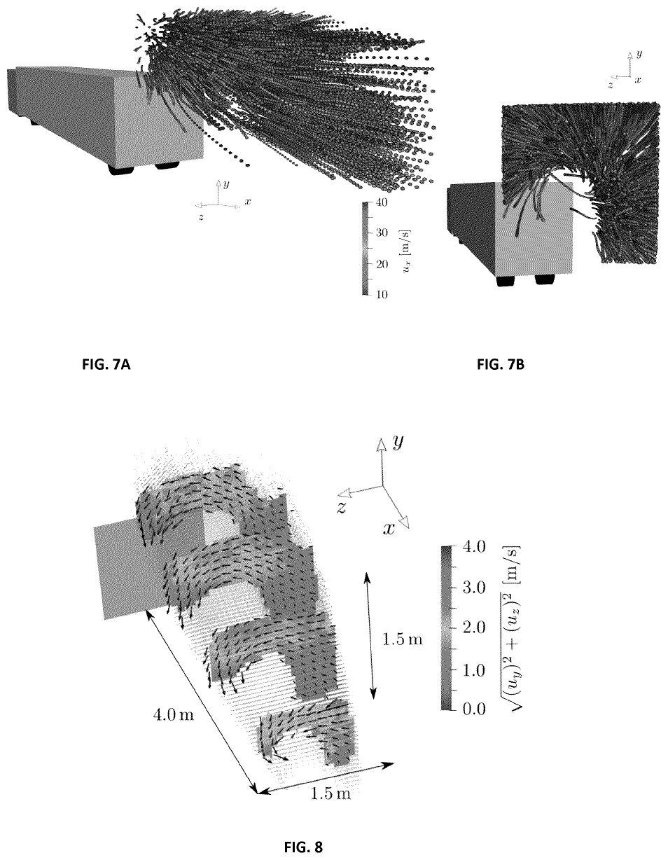

FIGS. 7A and 7B show two views of the trajectories extracted from a single run at U_{∞}=30 m/s. The visualizations show the streamwise velocity and capture the vortex evolving from the top-right edge of the trailer. The bubbles enter the measurement volume approximately at the end of the trailer and subsequently undergo a twisting motion due to the vortical structure in the wake of the trailer. The reconstructed trajectories presented in FIG. 8 do not represent an instantaneous flow field but the accumulation of trajectories over 10.8 s of measurement time. Therefore, temporal fluctuations of the streamwise velocity uₓ are apparent. A lack of bubbles in the lower-left corner of the measurement volume suggests that local seeding would be required to capture the full wake dynamics. In addition, very few bubbles were tracked in the vortex core. Close inspection of the recorded images revealed that the bubbles near the vortex center experienced significant deformation and/or bursting due to large pressure gradients and strong shear on the trailer edge. Moving outwards from the vortex center, the bubble density initially increases and then decreases again. The non-uniform distribution results in part from non-uniform seeding. In addition, since bubble size was estimated by photogrammetry, bubbles that did not appear in the field of view of camera B or C were not included.

FIG. 8 is a 3D plot of averaged velocity data at U_{∞}=30 m/s, showing in-plane velocity visualized by direction (vectors) and magnitude (contour plot) in four planes at different locations behind the model truck (shaded rectangle).

While the extracted Lagrangian data allows for direct determination of material accelerations, material transport, and the identification of coherent structures, the low object density in this proof-of-principle study (only two bubble generators used) does not allow one to extract spatial gradients in the time-resolved data set. In the following, the data is mapped on an Eulerian grid and averaged over time. A uniform 80×30×30 grid with a resolution of 0.05 m was defined and for each grid point the data were averaged. The mapping of the data to an equidistant Eulerian grid allows visualization of the mean velocity field, streamlines, as well as an estimate of the vorticity distribution.

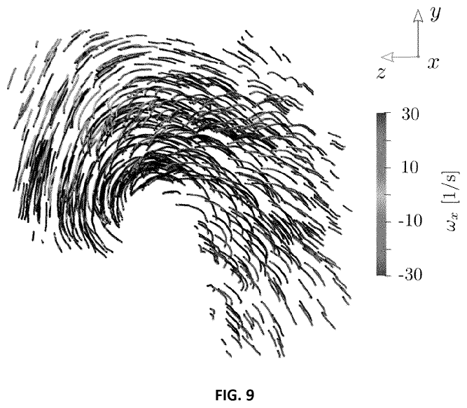

FIG. 9 shows the in-plane velocity at different streamwise locations in the wake based on its magnitude (\sqrt{u_{y}²+u_{z}²}). Again, the streamwise vortex is apparent and a large velocity magnitude in the negative y-direction is observed behind the truck. While no bubbles are present in the immediate vortex core itself, significant streamwise vorticity (ωₓ) is observed in close vicinity, as depicted in FIG. 9.

Despite the challenging environment of the large-scale wind tunnel (vibrations, issues with accurate alignment due to long distances, etc.) along with non-ideal seeding (low seeding density, narrow seeding area) the embodiment of this example was used successfully to extract time-resolved Lagrangian data as well as 3D time-averaged velocity fields for the model tractor-trailer.

The contents of all cited publications are incorporated herein by reference in their entirety.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

### REFERENCES

Abadi M et al. (2015) TensorFlow: Large-scale machine learning on heterogeneous systems. Software available from tensorflow.org
Cierpka C, Hain R, and Buchmann N A (2016) Flow visualization by mobile phone cameras. Experiments in Fluids 57:108
Cierpka C, Kahler C J (2012) Particle imaging techniques for volumetric three-component (3D3C) velocity measurements in microfluidics. J Visual 15(1):1-31
Elsinga G E, Scarano F, Wieneke B, van Oudheusden B W (2006) Tomographic particle image velocimetry. Exp Fluids 41(6):933-947
Fahringer T W, Lynch K P, Thurow B S (2015) Volumetric particle image velocimetry with a single plenoptic camera. Meas Sci Technol 26(11):115201
Gao Q, Wang H P, Wang J (2012) A single camera volumetric particle image velocimetry and its application. Sci China Technol Sci 55(9):2501-2510
Greenleaf A R (1950) Photographic optics. Macmillan, New York
Jux C, Sciacchitano A, Schneiders J F G, Scarano F (2018) Robotic volumetric PIV of a full-scale cyclist. Exp Fluids 59(4):74
Kao H P, Verkman A S (1994) Tracking of single fluorescent particles in three dimensions: use of cylindrical optics to encode particle position. Biophys J 67(3):1291-1300
Kurada S, Rankin G W, Sridhar K (1995) A trinocular vision system for close-range position sensing. Optics Laser Technol 27(2):75-79
Michaux F, Mattern P, Kallweit S (2018) RoboPIV: How robotics enable PIV on a large industrial scale. Meas Sci Technol 29(7):074009
Raffel M, Willert C E, Scarano F, Kahler C J, Wereley S T, Kompenhans J (2018) Particle image velocimetry: A practical guide. 3^{rd}. Springer, Verlag Berlin Heidelberg
Rosi G A, Sherry M, Kinzel M, Rival D E (2014) Characterizing the lower log region of the atmospheric surface layer via large-scale particle tracking velocimetry. Exp Fluids 55(5):1736
Scarano F, Ghaemi S, Caridi G C A, Bosbach J, Dierksheide U, Sciacchitano A (2015) On the use of helium-filled soap bubbles for large-scale tomographic PIV in wind tunnel experiments. Exp Fluids 56(2):42
Schanz D, Gesemann S, Schröder A (2016) Shake-The-Box: Lagrangian particle tracking at high particle image densities. Exp Fluids 57(5):70
Schneiders J F G, Scarano F, Jux C, Sciacchitano A (2018) Coaxial volumetric velocimetry. Meas Sci Technol 29(6):065201
Toloui M, Riley S, Hong J, Howard K, Chamorro L P, Guala M, Tucker J (2014) Measurement of atmospheric boundary layer based on super-large-scale particle image velocimetry using natural snowfall. Exp Fluids 55(5):1737
Willert C E, Gharib M (1992) Three-dimensional particle imaging with a single camera. Exp Fluids 12(6):353-358
Zhang Z (2000) A flexible new technique for camera calibration. IEEE Trans Pattern Anal Mach Intell 22(11):1330-1334
Zhao Z, Buchner A J, Atkinson C, Shi S, Soria J (2019) Volumetric measurements of a self-similar adverse pressure gradient turbulent boundary layer using single-camera light-field particle image velocimetry. Exp Fluids 60(9):141

1. A method for tracking movement of an object in three-dimensional (3D) space, comprising;
using a single sensor to obtain images of the object moving through the 3D space;
using a processor to:
determine a change in position of the object in the 3D space based on a change in size of the object in the images; and
use the change in position to construct a trajectory of the object;
wherein the trajectory represents the movement of the object through the 3D space.

2. The method of claim 1, wherein determining a change in size of the object in the images comprises:
determining a first size of the object in a first image at a first instance in time;
determining a second size of the object in a second image at a second instance in time;
using a difference in the first and second sizes of the object as the change in size of the object.

3. The method of claim 1, wherein determining a change in size of the object in the images comprises using an object detection algorithm.

4. The method of claim 1, wherein determining a change in size of the object in the images comprises:
detecting features in a first image of the object at a first instance in time;
detecting the features in a second image of the object at a second instance in time;
using the features in the first and second images to determine the change in size of the object.

5. The method of claim 4, wherein the features are glare points and the change in size of the object is determined by extracting temporal evolution of spacing of the glare points.

6. The method of claim 1, wherein the change in position of the object is determined two or more times.

7. The method of claim 1, comprising determining changes in positions of two or more objects in the images.

8. The method of claim 1, wherein the single sensor is adapted to capture images based on a modality selected from light (visible, infra-red (IR)), ultrasound (US), X-ray, radio frequency (RF), and magnetic resonance (MR).

9. The method of claim 1, wherein the single sensor comprises a camera.

10. The method of claim 1, wherein the object is naturally-occurring in the 3D space.

11. The method of claim 1, wherein the object is manufactured.

12. The method of claim 1, wherein the object is released into the 3D space.

13. The method of claim 7, wherein the objects are of substantially uniform size and shape.

14. The method of claim 7, wherein the objects comprise bubbles.

15. The method of claim 1, further comprising using the trajectory to characterize a flow field in the 3D space; and
outputting a 3D representation of the flow field.

16. Apparatus for tracking movement of an object in three-dimensional (3D) space, comprising;
a single sensor that captures images of the object moving through the 3D space;
a processor that:
determines a change in position of the object in the 3D space based on a change in size of the object in the images; and
uses the change in position to construct and output a trajectory of the object;
wherein the trajectory represents the movement of the object through the 3D space.

17. The apparatus of claim 16, wherein the processor determines the change in size of the object in the images by:
determining a first size of the object in a first image at a first instance in time;
determining a second size of the object in a second image at a second instance in time;
using a difference in the first and second sizes of the object as the change in size of the object.

18. The apparatus of claim 16, wherein the processor determines the change in size of the object in the images using an object detection algorithm.

19. The apparatus of claim 16, wherein the processor determines the change in size of the object in the images by:
detecting features in a first image of the object at a first instance in time;
detecting the features in a second image of the object at a second instance in time;
using the features in the first and second images to determine the change in size of the object.

20. The apparatus of claim 19, wherein the features are glare points and the change in size of the object is determined by extracting temporal evolution of spacing of the glare points.

21. The apparatus of claim 16, wherein the processor determines the change in position of the object two or more times.

22. The apparatus of claim 16, wherein the processor determines changes in positions of two or more objects in the images.

23. The apparatus of claim 16, wherein the single sensor is adapted to capture images based on a modality selected from light (visible, infra-red (IR)), ultrasound (US), X-ray, radio frequency (RF), and magnetic resonance (MR).

24. The apparatus of claim 16, wherein the single sensor comprises a camera.

25. The apparatus of claim 16, wherein the object is naturally-occurring in the 3D space.

26. The apparatus of claim 16, wherein the object is manufactured.

27. The apparatus of claim 17, wherein the object is released into the 3D space.

28. The apparatus of claim 22, wherein the objects are of substantially uniform size and shape.

29. The apparatus of claim 22, wherein the objects comprise bubbles.

30. The apparatus of claim 16, wherein the processor uses the trajectory to characterize a flow field in the 3D space and outputs a 3D representation of the flow field.
